(19) United States
(12) Patent Application Publication
(10) Pub. No.: US 2015/0130102 A1
(43) Pub. Date: May 14, 2015

(54) INSULATOR WITH EMBEDDED MASSES

(71) Applicant: Toyota Motor Eng. & Mtfg. North America, Inc., Erlanger, KY (US)

(72) Inventors: Gordon L. Ebbitt, Ann Arbor, MI (US); Todd M. Remtema, Milford, MI (US)

(73) Assignee: Toyota Motor Eng. & Mtfg. North America, Inc., Erlanger, KY (US)

(21) Appl. No.: 14/079,235

(22) Filed: Nov. 13, 2013

(51) Int. Cl. B29C 44/34; B29C 44/60; B29C 44/42

(52) U.S. Cl. CPC B29C 44/3442; B29C 44/42; B29C 44/60
USPC 264/45.3; 264/299; 425/162

(57) ABSTRACT

An insulator, especially a sound insulator, can be manufactured by introducing and mixing constituent compounds of a basis material for the insulator with masses to form an insulator mixture. The insulator mixture is formed into the insulator by a suitable mold or tool so that the masses are distributed within the insulator mixture. A catalyst can be included to control curing characteristics of the insulator.

### TECHNICAL FIELD

This application relates generally to insulators and insulation, such as acoustic insulation, that include embedded masses.

### BACKGROUND

A conventional insulator can be made of a foam material, which can be formed into a particular shape by a tool or mold by injecting compounds into the tool or mold.

### SUMMARY

In one implementation, manufacturing an insulator can include: introducing a first compound into a mixing head or nozzle; mixing a second compound with the first compound; mixing masses with the first compound and the second compound to form an insulator mixture; and introducing the masses and the first and second compounds into a mold to form the insulator with the masses distributed within the insulator mixture.

The mixing of the second compound with the first compound can be in the mixing head or nozzle. The mixing of the masses with the first compound and the second compound to form the insulator mixture can include introducing the masses to the first and second compounds after the mixing of the second compound with the first compound in the mixing head or nozzle. The masses can be mixed with the first and second compounds in the mold.

The mixing of the second compound with the first compound can include introducing a catalyst to one or both of the first and second compounds in or prior to the mixing head or nozzle. The mixing of the second compound with the first compound in the mixing head or nozzle can be after the mixing the catalyst with the first compound and the masses in the mixing head or nozzle. A blowing agent can be introduced to the mixing head or nozzle, or to one or more containers holding the first compound and/or the masses.

The mixing of the masses with the first compound and the second compound can include mixing the first compound and the masses in the mixing head or nozzle; and the mixing of the second compound with the first compound in the mixing head or nozzle can be after the mixing the first compound and the masses in the mixing head or nozzle.

A catalyst can be introduced to only the first compound, wherein the masses are mixed with the first compound after the catalyst is mixed with the first compound, and the second compound is mixed with the masses, the catalyst and the first compound to form the insulator mixture thereafter. The first compound, the masses and the catalyst can be mixed with the second compound in the mold. The catalyst can be mixed with the first compound and the masses in the mixing head or nozzle. Additional masses can be introduced directly to the insulator mixture in the mold thereafter.

The mixing of the masses with the first and second compounds can include mixing the first and second compounds and the masses in the mixing head or nozzle. Introducing the insulator mixture into the mold can be accomplished via a port connected to the mixing head or nozzle. The introducing of the insulator mixture can also be by injecting the insulator mixture into the mold. A blowing agent can be introduced to the mixing head or nozzle, or to one or more containers holding the first compound and/or the masses.

A plurality of valves can be controlled by a controller that respectively controls introduction of each of the first and second compounds and the masses. The control thereof can include: opening a first valve to introduce a predetermined amount of the first compound into the mixing head or nozzle; opening a second valve to introduce a predetermined amount of the second compound into the mixing head or nozzle; opening a third valve to introduce a predetermined amount of masses into the mixing head or nozzle at a same or different time of the opening the first and second valves to introduce the first and second compounds; and mixing the compounds and masses until the masses are evenly distributed throughout the mixture, resulting in the insulator mixture. The mixing of the masses with the first and second compounds to form the insulator mixture can include opening a fourth valve to introduce a predetermined amount of the catalyst to the insulator mixture. Further, a fifth valve can be opened to introduce a blowing agent to one or more of the first compound, the second compound, the catalyst, and the insulator mixture.

The mixing of masses with the first compound and the second compound to form the insulator mixture can include introducing the masses from separate first and second containers, wherein the first and second containers contain masses that differ based on one or more parameters, the parameters including size, shape, weight and density. The introducing of the masses from the first and second containers can be according to predetermined ratios and relative times to obtain an even distribution of the masses throughout the insulator mixture in the mold.

The first compound can be one of Isocyanate and Polyol, and the second compound can be the other of Isocyanate and Polyol.

In a further implementation, a computer-readable medium can include executable instructions, which when executed by circuitry, cause the circuitry to execute a process for manufacturing the insulator. In another implementation, an apparatus or system, such as a computer system, can include circuitry configured to execute a process for manufacturing the insulator.

The foregoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the disclosed embodiments and many of the attendant advantages thereof will be readily obtained as the same becomes better understood by reference to the following detailed description when considered in connection with the accompanying drawings, wherein:

FIG. 1A is a schematic illustration of an insulator;

FIG. 1B is a schematic illustration of a cross-section of the insulator including embedded masses;

FIG. 2 is a schematic illustration of a simplified system to form an insulator;

FIGS. 3A-3B is a schematic illustration of an insulator forming in a mold;

FIG. 4 is a schematic illustration of a system to form an insulator;

FIG. 5 is a schematic illustration of system to form an insulator utilizing a mixing nozzle;

FIG. 6 is an algorithm by way of a flowchart to form an insulator; and

FIG. 7 is an exemplary processing system as a controller.

### DETAILED DESCRIPTION OF EXEMPLARY IMPLEMENTATIONS

In the drawings, like reference numerals designate identical or corresponding parts throughout the several views. Further, as used herein, the words “a,” “an” and the like generally carry a meaning of “one or more,” unless stated otherwise.

Carpeted floor systems can be designed for high acoustic transmission loss by attaching a sheet of material with a high areal density to the back of a carpet face. This material is typically Ethyl Vinyl Acetate (EVA), which has been loaded with calcium carbonate or barium sulfate.

These floor systems can also include a mechanical decoupler that separates the carpet and EVA layer from the sheet metal floor of the vehicle. This layer is called an underpad.

The mass of the high density material and the compliance of the decoupler creates a mechanical resonance, that is typically in the region of around 200 to 500 Hz. At the resonant frequency, the acoustic transmission loss performance of the floor systems is very poor or worse than not having any acoustic insulator/treatment provided at all.

Above the resonance frequency, the performance improves. In particular, high frequency performance can be achieved at levels such that the poor performance in the low frequency range can be considered a reasonable compromise.

An alternative insulator that reduces the weight of the system (i.e., a lightweight solution) with better low frequency performance can utilize a structure that substitutes a stiff airflow resistive material for the high areal density material. This alternative eliminates the resonance and the performance degradation found at the resonance, and provides a floor system with high absorption. However, particularly/relatively high transmission loss at any frequency is not provided. Further, aside from a lack of degradation at resonance, this lightweight solution does not provide much absorption or transmission loss at low frequencies.

Aspects of this disclosure relate to manufacturing an insulator, such as an acoustic insulator, including masses referred to as embedded mass (i.e., masses that are embedded in an insulator). Embedded masses in an insulator vibrate at different resonant frequencies determined by the masses and the positions of the masses throughout the insulator mixture and the compliance of the basis structure of the insulator (e.g., a foam). This structure can provide both increased transmission loss and absorption, thereby providing an acoustic insulator. In particular, it can assist in providing improved performance in a low frequency range of sound less than 1000 Hz and/or especially between 200 and 500 HZ.

Aspects of this disclosure are directed to improving a low frequency (<1000 Hz) performance of acoustic insulators. Exemplary implementations include automotive floor systems and dash insulators, though insulators and acoustic insulators can be applied to other areas and industries.

Aspects of this disclosure are directed to manufacturing an insulator with embedded masses by introducing the masses to the insulator while the insulator is being manufactured.

In architectural applications, acceptable low frequency acoustic performance of an insulator is usually achieved through the use of materials that are thick or massive. This is problematic for acoustic insulators in automotive and aerospace applications where mass and packaging space are generally minimized.

A particular area of concern is an automotive floor system, where a lot of low frequency noise can enter a vehicle. Mass-backed carpets provide acceptable/good high frequency performance, but degrade the performance in the frequency range where the floor system has its resonance (typically 200 Hz to 500 Hz for the thicknesses and masses used in automotive applications).

Lightweight floor systems that do no utilize a mass-backed carpet will not have this low frequency degradation and they can provide improved absorption, but they do not provide much low frequency absorption or transmission loss.

In accordance with the described exemplary implementations of this disclosure, a number of small objects (referred to as masses) can be introduced into a foam substrate that can be used as a carpet underpad, dash insulator, or other insulator treatment. These objects resonant and dissipate energy from, e.g., a sheet metal floor of a vehicle before it is transmitted into an interior of the vehicle.

By varying one or more of object size, shape, density and material, each object has a different resonant frequency and there is no dip in insulator/resonant frequency performance as seen with conventional mass-backed floor systems.

A polyurethane foam is conventionally utilized in automotive applications by mixing Isocyanate and Polyol through a mixing nozzle, and then injecting the mixture into a closed mold or pouring it into an open clamshell mold that is closed after the mixture is poured. As the mixture cures it creates a uniform foam the fills the mold.

Although aspects of this disclosure pertain specifically to the use polyurethane form as a basis material for an insulator, it should be appreciated that other foams could be utilized, including latex or rubber foams and polyethylene foam. That is, the teachings of this disclosure are not limited to only polyurethane foam.

Furthermore, although aspects of this disclosure specifically pertain to the use of a foam, which is formed by a plurality of small gas or air bubbles in a liquid, which is then cured to a solid, an insulator can also be formed in accordance with the teachings of this disclosure that do not require the formation of a plurality of small gas or air bubbles in a liquid, and that the liquid can cure to a solid without the formation of the small gas or air bubbles.

By mixing small masses with the Isocyanate and Polyol mixture (i.e., for a polyurethane foam insulator) as it is introduced into the mold, these masses will be diffused throughout the mold. These masses have a higher density than the cured polyurethane foam (approximately 40 kg/m3) and will typically have a density lower than 8500 kg/m3. The objects/masses can range in size from approximately 1 mm in diameter to 20 mm in diameter.

The shape of the objects is a secondary importance, but does effect performance. Specifically, non-spherical objects provide additional resonances and enhanced performance not obtained from spherical/round shapes.

The small masses can be mixed directly with a first compound (e.g., the Polyol) and/or a second compound (e.g., the Isocyanate) in a mixing head or be added by one or more separate nozzles, spouts or ports.

As a result, a number of particles are embedded into a decoupler to create numerous resonances. The resonances are functions of the mass of the particles and the compliance and damping of the decoupler. The compliance of the decoupler is determined by the mechanical properties of the decoupler itself and also the distance between the particles and the bottom of the floor system. That is, the greater the distance, the higher the compliance. Multiple resonances are created by using particles of varying masses and having them at a variety of positions throughout the decoupler. However, the shape, density, and material of the particles can also be varied to obtain the multiple resonances.

The figures, discussed below, illustrate exemplary implementations of manufacturing an insulator with embedded particles (also referred to as masses or objects).

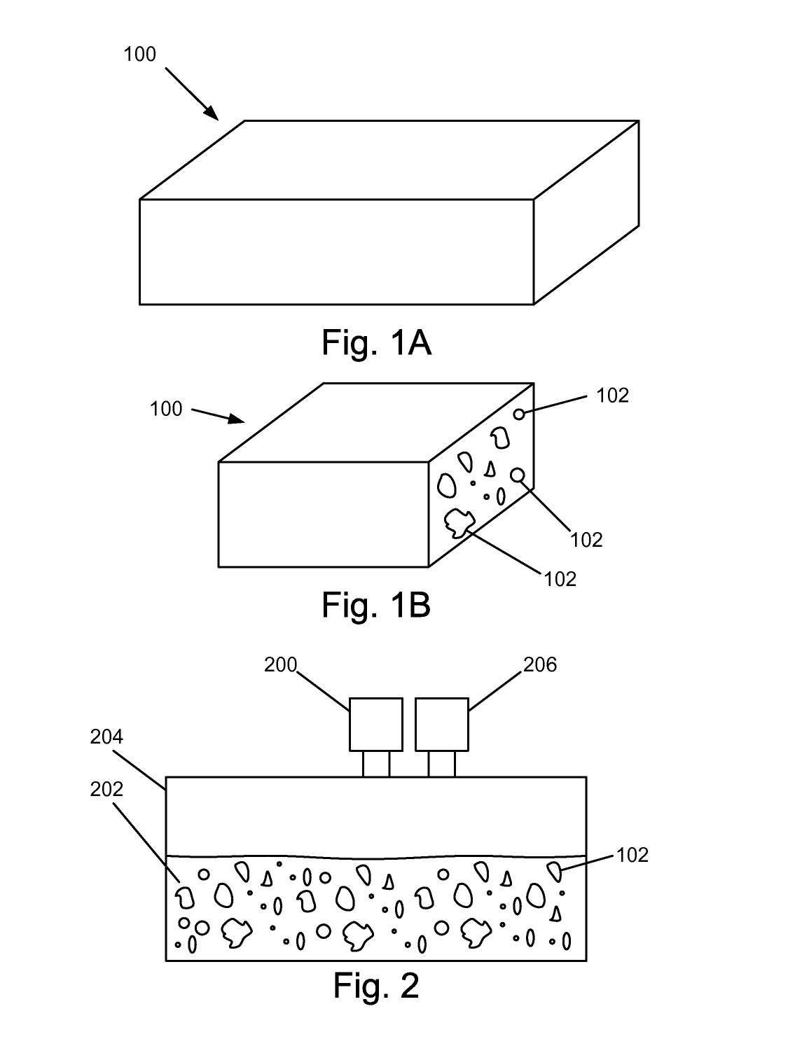

FIG. 1A illustrates an insulator 100 (e.g., a polyurethane foam block) of an arbitrary shape. FIG. 1A illustrates the insulator as a prism shape, but it should be appreciated any other shape can be utilized based on a mold or tool used to form the shape.

FIG. 1B is an illustrative view of a cross-section of the insulator 100. In FIG. 1B, the insulator 100 is shown to include a plurality of masses 102 embedded throughout the foam. By controlling manufacturing parameters, the distribution of the masses 102 within the insulator 100 can be controlled to achieve a regular or even distribution of the masses 102 though the insulator 100.

FIG. 2 is simplified schematic view of a manufacturing system to manufacture the insulator 100. In FIG. 2, a head 200 ejects an insulator mixture 202 into a mold or tool 204. The insulator mixture 202 is, e.g., a foam mixture in a liquid state. The foam can be a polyurethane foam, which can be made by mixing two compounds: Polyol and Isocyanate or other known compounds. Distributed throughout the mixture 202 are masses 102 of different shapes, masses, densities and/or material. The mold 204 can be of any desired shape, size or volume. The masses 102 can be ejected into the mold 204 by the head 200 or by a separate head 206.

The head 200 and/or the head 206 can be connected to the mold 204 by a one-way valve or by a closeable port. The mold 204 may also be provided with one or more one-way valves or exhaust ports to exhaust excess insulator mixture 202 and/or gases in the interior of the mold 204.

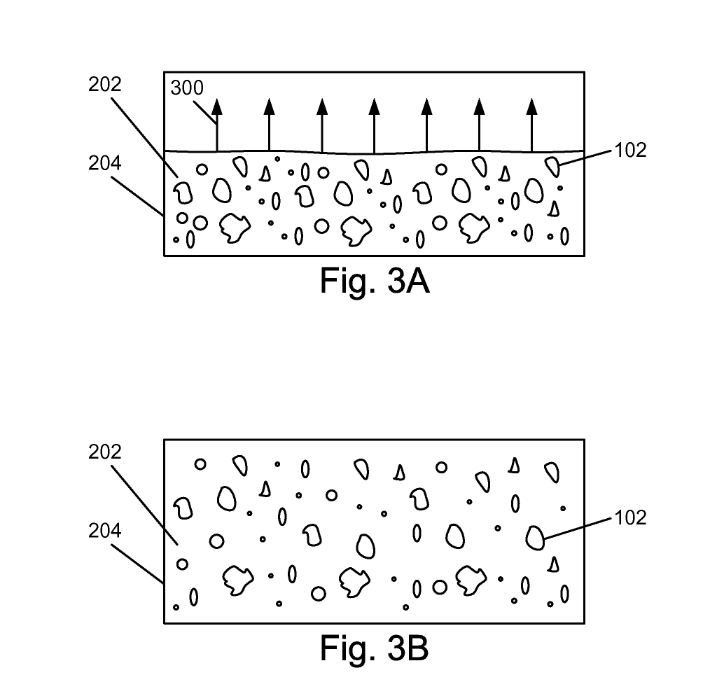

FIGS. 3A-B illustrates a simplified curing process of the insulator mixture 202 from a liquid of or pre-foam state to a solid state. In the curing process, with reference to FIG. 3A, the insulator mixture 202 will expand in the direction of arrows 300 to occupy the interior of the mold 204. After the mixture is completely cured, it is transformed from a liquid or pre-foam state to a solid state, thereby taking the shape of the mold 204. During the curing process, the insulator mixture 202 undergoes a density change of about 10:1. That is, the volume of the insulator mixture increases by an order of magnitude (e.g., 10 times) to a solid, cured state as illustrated in FIG. 3B.

The curing process can begin at the time the compounds constituting the insulator mixture are mixed. For example, when two or more compounds (e.g., Polyol and Isocyanate) are mixed, curing begins. The masses can be combined or mixed with the compounds prior to or during various stages of curing. That is, the masses can be combined with one compound, and then the combination can be mixed with the second compound and introduced into the mold, but various modifications, as discussed below, can be made as to the order of combining. Further, the masses can be added to the insulator mixture after the constituent compounds are mixed, but before the curing process is complete. In one particular implementation, the mold is filled partly with the constituent compounds, and then masses are introduced separately. After a predetermined amount of masses are introduced, a flow of the constituent compounds to the mold is stopped, and insulator mixture is allowed to cure. Other implementations are discussed in the following descriptions.

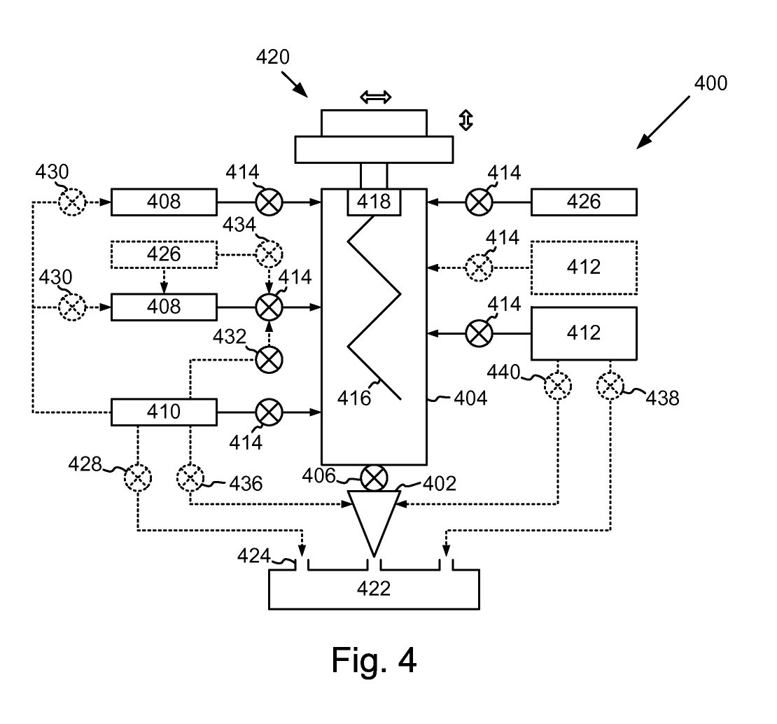

FIG. 4 is a schematic illustration of an exemplary system 400 to manufacture an insulator with embedded masses according to one implementation of this disclosure. FIG. 4 illustrates the system 400 as including a nozzle 402 that is connected to a mixing head 404 and opened and closed by a controller-controlled valve 406. The mixing head 404 is connected to two or more compound containers 408, a catalyst container 410 and to one or more masses containers 412. However, other connections are possible, as illustrated in FIG. 4 and discussed below in more detail.

The connected containers 408, 410 and 412 introduce content to the mixing head 404 through respective controller-controlled valves 414. A mixing rod 416 is located in the mixing head 404 and is connected to a motor 418 to mix content within the mixing head 404. The mixing head 404 is movable. Specifically, the mixing head 404 can be moved up, down, left and right via a robotic articulator 420. The articulator 420 can also rotate the mixing head 404. The movements can be utilized to connect and/or disconnect the nozzle 402 to/from a mold or tool, or to move the nozzle 402 between different molds or portions of a single mold via, e.g., different ports of the mold.

In the exemplary implementation of FIG. 4, a controller (e.g., a processing system as discussed below) can close the nozzle valve 406 and control the plurality of valves 414 to introduce each of the first and second compounds in the containers 408, the catalyst in the container 410, and the masses in the container 412, respectively, according to predetermined timings, ratios and orders. In particular, predetermined amounts of the compounds, masses and catalyst can be introduced to the mixing head 404 at the same or different times. The motor 418 is activated by a controller to control the mixing rod 416 to mix the introduced compounds, catalyst and masses. In another implementation, one of the first and second compounds can be directly introduced from the compounds containers 408 into the mold 422 through a corresponding controller-controlled valve.

The masses from the container 412 can be fed to the mixing head 404 by gravity feeding, through a piston or by another particle transfer mechanism. The compounds and the catalyst, which are generally all liquids, can be fed to the mixing head 404 by gravity feeding, plungers, or pressure.

The controller then opens the nozzle valve 406 and either releases or injects the formed mixture into a desired mold 422 via a port 424, which can be one of several ports of the mold 422. Additionally, the system 400 can include a pressure source (e.g., a pressurized gas tank that provides a blowing agent) 426 to inject contents of the mixing head 404 into the mold 422 at an elevated pressure. The pressure source 426 can utilize or include CO₂ or another gas and can be connected to the mixing head 404 by one of the valves 414.

As discussed above, the system 400 can include multiple containers 412 to respectively hold different masses. The masses between the multiple containers 412 can vary by parameters such as weight, density, shape and/or average size. The masses in each of the multiple containers can be within a certain predefined range of one or more of the parameters. Further, in one container 412, separate compartments can be provided to compartmentalize masses of different parameters or characteristics that are delivered from the container 412 to, e.g., the mixing head 404.

The system 400 can include a direct catalyst release controller-controlled valve 428 to release catalyst directly to the mold 422. The catalyst can be released into the mold 422 before, during or after content from the mixing head 404 is delivered to the mold 422. Similarly, one or more of the compound containers can be connected by a controller-controlled valve to the mold 422 to introduce one or more compounds directly to the mold 422 for mixing therein.

The catalyst container 410 can also be connected directly to one or more of the compound containers 408, and the catalyst can be controllably introduced to one or more of the compound containers 408 by controller-controlled valves 430. In an exemplary implementation, the catalyst can be introduced directly with Polyol that is included in one of the compound containers 408.

Specifically, the catalyst can be controlled to be introduced into the container 408 containing Polyol via the valve 430 or at a point between the container 408 and the mixing head 404 via valve 432. In such an implementation, the valve 414 connected between the container 408 containing Polyol and the mixing head connects to the catalyst container 410 via valve 432 and acts as a mixing valve for the Polyol and the catalyst.

The catalyst is generally not introduced directly into the mold 422 via the valve 428 because the catalyst may not mix thoroughly. Further, the catalyst is generally not introduced with anything other than the Polyol (e.g., a blowing agent, other additives or Isocyanate), but this is not limiting. Although not preferred, the catalyst can be introduced in any combination according to this disclosure. Further, a catalyst, blowing agent, or other additives are not generally introduced directly with Isocyanate, but this is not limiting and various combinations are possible.

The pressure source 426, which provides a blowing agent, in one implementation can be connected, via a controller-controlled valve 434, to the valve 414 that is connected between the container 408 that includes Polyol and the mixing head 404. Here, the valve 414 acts as a mixing/combining valve for the Polyol, the blowing agent, and/or the catalyst. In another implementation, the pressure source 426 can be directly connected to the container 408 that includes Polyol, e.g., by a corresponding controller-controller valve. In another implementation, the catalyst can be introduced to the nozzle 402 via a controller-controlled valve 436.

The content delivered from the mixing head 404 to the mold 422 includes one of: (1) one or more compounds that constitute or form a basis material (e.g., polyurethane) for an insulator; (2) the one or more compounds and masses; (3) the one or more compounds and a catalyst; (4) the one or more compounds, the catalyst, and the masses; (5) all of the compounds that constitute or form the basis material and varying combinations of the catalyst and the masses; and (6) only a portion of the masses to be delivered and a combination of the catalyst and one or more of the compounds. However, other combinations are possible.

When only a portion of the masses or none of the masses are delivered to the mold 422 through the mixing head 404, all or the remaining portion of the masses is delivered directly to the mold 422 from the container 412 through a direct mass release controller-controlled valve 438. Thus, the masses can be partially delivered to the mold 422 via the mixing head and directly to the mold 422 in parallel. Similarly, the catalyst can be partially delivered to the mold 422 via the mixing head and directly to the mold 422 in parallel. A portion or all of the masses can also be introduced to the nozzle 402 via the controller-controlled valve 440.

As discussed above, multiple mass containers can be provided. For example, multiple containers 412 can be provided. Further, the pressure source 426 can be connected to one or more of valves 406, 438, and 440 to provide a blowing agent at one or more of these valves. Further, the pressure source 426 can be connected to the nozzle 402.

In view of the above discussion and the following descriptions, it should be appreciated that multiple controller-controlled valves can be provided respectively between the various components of a manufacturing apparatus/system for manufacturing an insulator. In view thereof, a plurality of implementations can be obtained in light of the teachings of this disclosure, where the stages at which a blowing agent, catalyst, masses, and the first and second compounds can be varied, such that the timing, order and location of the introduction of these contents can be varied. As a result, an implementation in accordance with this disclosure may depart from the explicit order and mixing locations described herein.

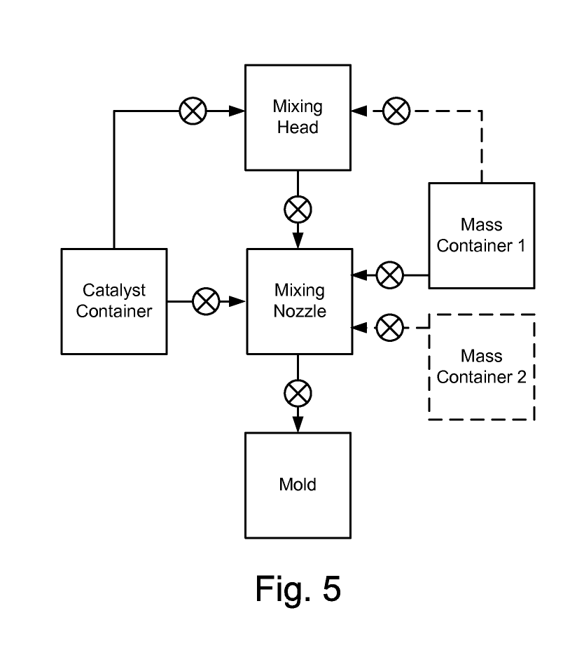

FIG. 5 schematically illustrates an example in which mass container 1 and mass container 2 are provided. The mass containers 1 and 2 can include two different types of masses. The different types can include one or more of the above-discussed parameters or ranges of parameters. Further, additional mass containers can be provided.

The mass containers can be connected to a mixing nozzle that is connected to a mold by a valve. The mass containers can also be connected to a mixing head, as illustrated in FIG. 4, and the other structures and connections in FIG. 4 can also be provided in the implementation illustrated in FIG. 5.

In FIG. 5, the mixing head and a catalyst container are connected by respective valves to the mixing nozzle. The mixing nozzle is a nozzle that combines the various content inputs utilizing a pressure of an inputted content or an interior contour of the nozzle that promote a vortex or turbulent interaction between the input contents to obtain appropriate mixing. Pressure and/or a blowing agent can be provided directly or indirectly to the mixing nozzle by a pressure source such as a CO₂ tank.

The various valves illustrated in FIGS. 4-5 are controlled by a processing system that meters content into the mixing nozzle according to predetermined ratios amounts and timings. To this extent each of the valves can be accompanied by a corresponding sensor that measures an amount of content passing therethrough.

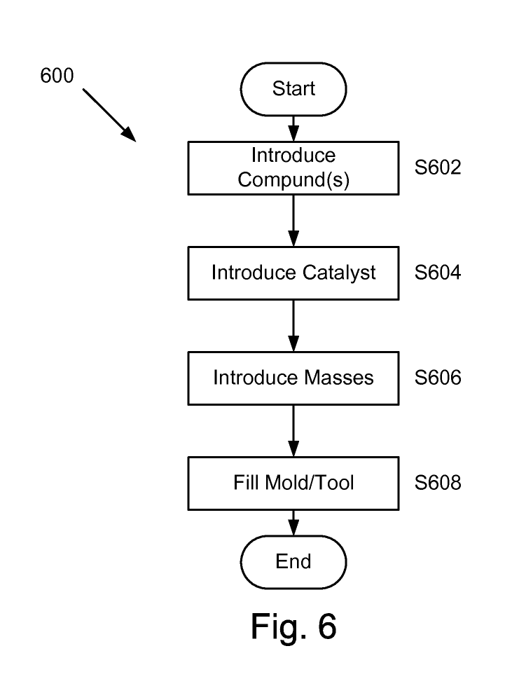

FIG. 6 illustrates an algorithm 600 by way of a flowchart for manufacturing an insulator utilizing the systems described herein. At S602, a controller introduces a predetermined amount of one or more of compounds that constitute a basis material for an insulator into a mixing head or nozzle. For example, one or two compounds can be introduced into a mixing head at S602.

A catalyst is introduced at S604 and masses are introduced at S606 via the controller. The catalyst and the masses can be introduced at the same or different times, and can be introduced into the mixing head or nozzle at the same or different times with respect to the compounds. At S608, the masses, catalyst and compounds are introduced into the mold, and the resulting mixture cures in the mold to form the insulator.

The introduction of catalyst at S604 is optional, and can be omitted. Further, the order of steps can be changed. In particular, the masses can be introduced to the mold prior to the introduction of one particular compound or any compounds. Further, the compounds can be introduced to the mold prior to the introduction of any masses. Thereby, the masses can be introduced to one or more of the compounds to control a timing of introducing the masses with respect to a curing state of the constituent compounds of the basis of the insulator.

Moreover, the introduction of masses at S606 can be divided into several separate steps, in which masses are introduced at a first timing and masses are introduced at a second timing. Masses can also be introduced at third, fourth, etc. timings. The masses introduced at the timings can all be of a common parameter or characteristic. In another implementation, the masses introduced at the timings can vary in parameters or characteristics to control a distribution of the masses within the insulator.

The order of the steps illustrated in FIG. 6 can be changed or reversed. Further, the introduction of a catalyst can be omitted in some implementations, and the introduction of a blowing agent can be included in some implementations.

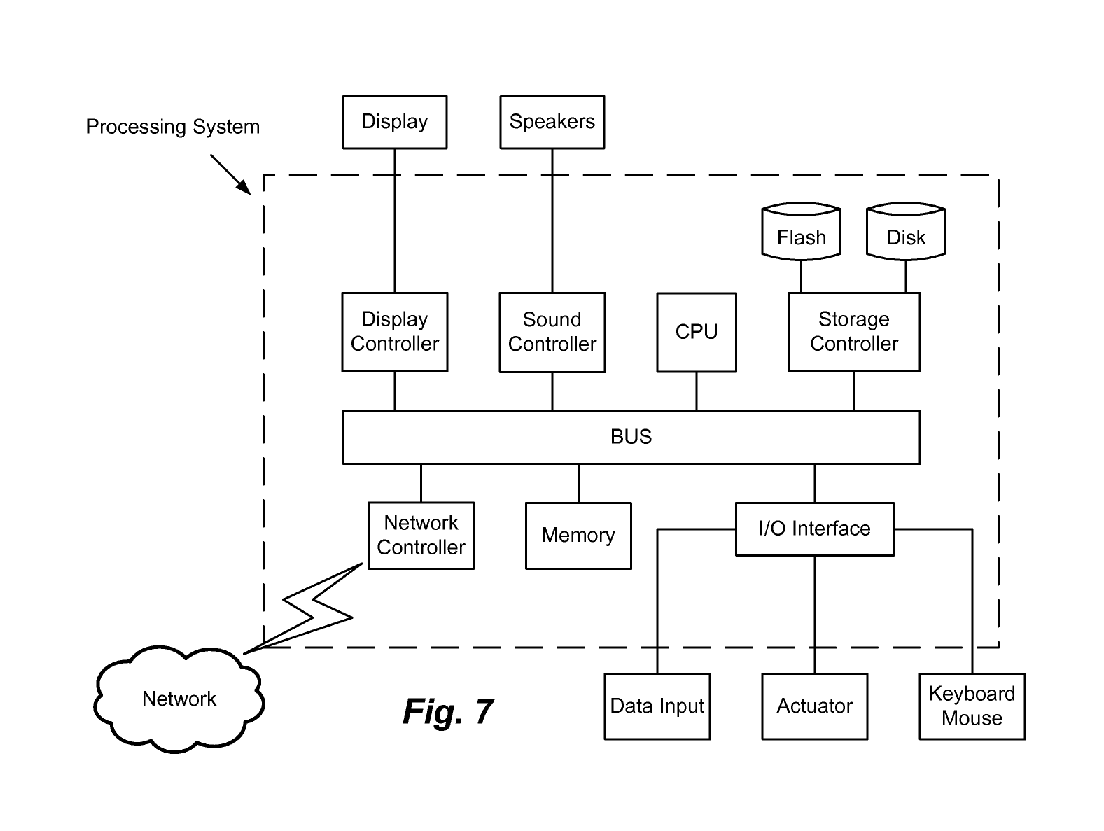

An exemplary processing system is illustrated in FIG. 7, which is an exemplary implementation of a controller. This exemplary processing system can be implemented using one or more microprocessors or the equivalent, such as a central processing unit (CPU) and/or at least one application specific processor ASP (not shown). The microprocessor is a circuit or circuitry that utilizes a computer readable storage medium, such as a memory circuit (e.g., ROM, EPROM, EEPROM, flash memory, static memory, DRAM, SDRAM, and their equivalents), configured to control the microprocessor to perform and/or control the processes and systems of this disclosure, and configured to execute the algorithms described herein. Other storage mediums can be controlled via a controller, such as a disk controller, which can controls a hard disk drive or optical disk drive.

The microprocessor or aspects thereof, in alternate implementations, can include or exclusively include a logic device for augmenting or fully implementing aspects of this disclosure. Such a logic device includes, but is not limited to, an application-specific integrated circuit (ASIC), a field programmable gate array (FPGA), a generic-array of logic (GAL), and their equivalents. The microprocessor can be a separate device or a single processing mechanism. Further, this disclosure can benefit from parallel processing capabilities of a multi-cored CPU and a graphics processing unit (GPU) to achieve improved computational efficiency. One or more processors in a multi-processing arrangement may also be employed to execute sequences of instructions contained in memory. Alternatively, hard-wired circuitry may be used in place of or in combination with software instructions. Thus, the exemplary implementations discussed herein are not limited to any specific combination of hardware circuitry and software.

In another aspect, results of processing in accordance with this disclosure can be displayed via a display controller to a monitor. The display controller preferably includes at least one graphic processing unit, which can be provided by a plurality of graphics processing cores, for improved computational efficiency. Additionally, an I/O (input/output) interface is provided for inputting signals and/or data from microphones, speakers, cameras, a mouse, a keyboard, a touch-based display or pad interface, etc., which can be connected to the I/O interface as a peripheral. For example, a keyboard or a pointing device for controlling parameters of the various processes or algorithms of this disclosure can be connected to the I/O interface to provide additional functionality and configuration options, or control display characteristics. Moreover, the monitor can be provided with a touch-sensitive interface for providing a command/instruction interface.

The above-noted components can be coupled to a network, such as the Internet or a local intranet, via a network interface for the transmission or reception of data, including controllable parameters. A central BUS is provided to connect the above hardware components together and provides at least one path for digital communication there between.

The functional processing or controlling described herein can also be implemented in specialized circuitry or one or more specialized circuits including circuits to perform the described processing. Such circuits can be a part of a computer processing system or a discrete device that is interconnected to other systems. A processor in accordance with this disclosure can also be programmed to or configured to execute the functional processing described herein by computer code elements.

Further, the processing systems, in one implementation, can be connected to each other by a network or other data communication connection. One or more of the processing systems can be connected to corresponding actuators to actuate the valves, control movement of the mixing head or the mixing valve, and receive inputs from the sensors.

Suitable software can be tangibly stored on a computer readable medium of a processing system, including the memory and storage devices. Other examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other medium from which a computer can read. The software may include, but is not limited to, device drivers, operating systems, development tools, applications software, and/or a graphical user interface.

Computer code elements on the above-noted medium may be any interpretable or executable code mechanism, including but not limited to scripts, interpretable programs, dynamic link libraries (DLLs), Java classes and complete executable programs. Moreover, parts of the processing of aspects of this disclosure may be distributed for better performance, reliability and/or cost.

The Data Input portion of the processing system accepts input signals from, e.g., the sensors and/or the valves by, e.g., respective wired connections. A plurality of ASICs or other data processing components can be provided as forming the Data Input portion, or as providing input(s) to the Data Input portion.

While certain implementations have been described, these implementations have been presented by way of example only, and are not intended to limit the scope of this disclosure. The novel devices, systems and methods described herein may be embodied in a variety of other forms; furthermore, various omissions, substitutions, and changes in the form of the devices, systems and methods described herein may be made without departing from the spirit of this disclosure. The accompanying claims and their equivalents are intended to cover.

1. A method of manufacturing an insulator, comprising:
introducing a first compound into a mixing head or nozzle;
mixing a second compound with the first compound;
mixing masses with the first compound and the second compound to form an insulator mixture; and
introducing the masses and the first and second compounds into a mold to form the insulator with the masses distributed within the insulator mixture.

2. The method according to claim 1, wherein the mixing the second compound with the first compound is in the mixing head or nozzle.

3. The method according to claim 2, wherein the mixing the masses with the first compound and the second compound to form the insulator mixture includes introducing the masses to the first and second compounds after the mixing the second compound with the first compound in the mixing head or nozzle.

4. The method according to claim 3, wherein the masses are mixed with the first and second compounds in the mold.

5. The method according to claim 2, wherein the mixing the second compound with the first compound includes introducing a catalyst to one or both of the first and second compounds in or prior to the mixing head or nozzle.

6. The method according to claim 5, wherein:
the mixing the second compound with the first compound in the mixing head or nozzle is after the mixing the catalyst with the first compound and the masses in the mixing head or nozzle; and
the method further includes introducing a blowing agent to the mixing head or nozzle, or to one or more containers holding the first compound or the masses.

7. The method according to claim 2, wherein:
the mixing the masses with the first compound and the second compound includes mixing the first compound and the masses in the mixing head or nozzle; and
the mixing the second compound with the first compound in the mixing head or nozzle is after the mixing the first compound and the masses in the mixing head or nozzle.

8. The method according to claim 1, further comprising:
introducing a catalyst to only the first compound, wherein the masses are mixed with the first compound after the catalyst is mixed with the first compound, and the second compound is mixed with the masses, the catalyst and the first compound to form the insulator mixture thereafter.

9. The method according to claim 8, wherein the first compound, the masses and the catalyst are mixed with the second compound in the mold.

10. The method according to claim 8, wherein the catalyst is mixed with the first compound and the masses in the mixing head or nozzle.

11. The method according to claim 8, further comprising:
introducing additional masses directly to the insulator mixture in the mold.

12. The method according to claim 1, wherein the mixing the masses with the first and second compounds includes mixing the first and second compounds and the masses in the mixing head or nozzle.

13. The method according to claim 12, wherein the introducing the insulator mixture into the mold is by injecting the insulator mixture into the mold by a port connected to the mixing head or nozzle, including:
introducing a blowing agent to the mixing head or nozzle, or to one or more containers holding the first compound or the masses.

14. The method according to claim 3, further comprising controlling a plurality of valves by a controller that respectively controls introduction of each of the first and second compounds and the masses, the controlling including:
opening a first valve to introduce a predetermined amount of the first compound into the mixing head or nozzle;
opening a second valve to introduce a predetermined amount of the second compound into the mixing head or nozzle;
opening a third valve to introduce a predetermined amount of masses into the mixing head or nozzle at a same or different time of the opening the first and second valves to introduce the first and second compounds; and
mixing the compounds and masses until the masses are evenly distributed throughout the mixture, resulting in the insulator mixture.

15. The method according to claim 14, wherein the mixing the masses with the first and second compounds to form the insulator mixture includes:
opening a fourth valve to introduce a predetermined amount of the catalyst to the insulator mixture; and
opening a fifth valve to introduce a predetermined amount of a blowing agent to one or more of the first compound, the second compound, the catalyst, and the insulator mixture.

16. The method according to claim 1, wherein the mixing masses with the first compound and the second compound to form the insulator mixture includes:
introducing the masses from separate first and second containers, wherein the first and second containers contain masses that differ based on one or more parameters, the parameters including size, shape, weight and density.

17. The method according to claim 16, wherein the introducing of the masses from the first and second containers is according to predetermined ratios and relative times to obtain an even distribution of the masses throughout the insulator mixture in the mold.

18. The method according to claim 1, wherein the first compound is one of Isocyanate and Polyol, and the second compound is the other of Isocyanate and Polyol.

19. A computer-readable medium including executable instructions, which when executed by circuitry, cause the circuitry to execute a process, comprising:
introducing a first compound into a mixing head or nozzle;
mixing a second compound with the first compound;
mixing masses with the first compound and the second compound to form an insulator mixture; and
introducing the masses and the first and second compounds into a mold to form the insulator with the masses distributed within the insulator mixture.

20. An apparatus for manufacturing an insulator, comprising circuitry configured to:
introduce a first compound into a mixing head or nozzle;
mix a second compound with the first compound;
mix masses with the first compound and the second compound to form an insulator mixture; and
introduce the masses and the first and second compounds into a mold to form the insulator with the masses distributed within the insulator mixture.
